(19) United States
(12) Patent Application Publication
(10) Pub. No.: US 2003/0032451 A1
(43) Pub. Date: Feb. 13, 2003

(54) Architecture for converged broadband wireless communications

(76) Inventor: Jianhong Hu, Cuperitno, CA (US)

Correspondence Address: JIANHONG HU, 1218 BUBB ROAD, CUPERTINO, CA, 95014, US

(21) Appl. No.: 09/927,075

(22) Filed: Aug. 10, 2001

(51) Int. Cl. H04M 1/00

(52) U.S. Cl. 455/560; 455/552; 455/426

(57) ABSTRACT

The architecture for converged broadband wireless communications comprises two separate parts with different functionality. The first part, called converged wireless terminal, supports any common air interfaces (wireless standards) of either wireless mobile system or wireless access system, wherein a Common Air Interface Basic Input/Output System (CAI-BIOS) is the key function element. The second part, called Common Access Point, supports any said air interfaces to the said converged wireless terminal, and also supports any network interfaces to the A11-IP or Packet Division Multiplexed backbone networks. The two parts construct a new architecture for the convergence of broadband wireless access and wireless mobile communications.

### BACKGROUND OF THE INVENTION

1. Field of the Invention

The invention relates to the architecture and system/network model for next generation broadband wireless communications which will be the convergence of broadband wireless access systems, wireless mobile systems and networks, wireless local area networks, wireless personal access networks, wireless local loop and other wireless systems and networks.

The invention focuses on the new architecture on the design of Converged Wireless Terminal and the Common Access Point to the next generation backbone (or core) networks.

2. Description of the Prior Art

Generally, wireless communications need at least one wireless end terminal and one base station. For different wireless applications, the technology of wireless transmission is different. In a whole, there are two different wireless communications: wireless mobile and wireless access systems. Wireless mobile system includes wireless cellular system and wireless satellite system where the wireless terminal can be mobile anywhere in the service areas. A handover or mobility control is needed when the user (with the wireless terminal) leaves his/her current base station covered area and enters another area, in order to continue the communications. Therefore, other more equipments are required in the conventional mobile systems, for example, Base Station Controlled and Mobile Switching Center.

A wireless access system may include fixed wireless access system, wireless trunking system, wireless local area network, wireless local loop or wireless personal access networks, etc where a large area handover or mobility control is not needed. Depending on the applications, different equipments may be required in the conventional wireless access systems.

The current wireless architecture requires each system must use its own equipments and each wireless terminal can only support one single wireless standard (we call “Air-Interface”). Also, each Base Station can only support one single air-interface.

With the very fast development of wireless technologies, many new wireless standards come out everyday all over the world. If this situation continues, the wireless world will be very crowded and messed-up, and the system cost is very expensive.

By looking at all the existing wireless systems (mobile or access), most of the technical issues are similar, only few issues need to be considered for different air-interfaces.

The network technologies have been developing very fast in the recent years. The traditional “circuit-switched” networks (low efficiency and dumb hop-by-hop signaling) are giving the way to “packet-switched” networks where the user uses the network resources by bits instead of by time slot. This new packet networks have become the driver for the Internet world where the IP (internet protocol) based packet network is almost dominating the network world. Therefore, the “All-IP” model was proposed to extend the IP to the end-terminal where the user can fully use the network resources and pay by the transmitted useful bits.

This All-IP model greatly improves the network infrastructure because it integrates the traditional switching and networking into one, and all the switching can be done in the backbone (or called “Core”) All-IP networks or simply no switching is needed.

While the backbone networks are going to be mature, the existing wireless systems are still separately operated, configured and manufactured in different air-interfaces which are very expensive and not cost effective.

### SUMMARY OF THE INVENTION

As a very innovative solution, this invention provides a complete convergence of broadband wireless access and wireless mobile systems, including GSM, GPRS, UMTS (W-CDMA), Wireless LAN (IEEE 802.11 or HiperLAN), Broadband Wireless Access (IEEE 902.16 or HiperAccess), Wireless PAN (IEEE 802.15) and Wireless Local Loop (DECT or PHS), etc.

This convergence is very important in that:

1. The same terminal (called “Converged Wireless Terminal”) can support different air-interfaces by using related SIM card or Memory Stick containing necessary air-interface modules, etc.

2. The terminal can automatically or manually select the optimal air-interface for communications.

3. The base station and/or other wireless base equipments can be integrated into one Common Access Point (CAP) which is accessible to ALL-IP or any PDM (Packet Division Multiplex) backbone networks.

4. The CAP is an open function entity to both the different air-interfaces and the different network-interfaces (for example: Fiber Optical, Digital Subscriber Line, Cable, ATM, Ethernet, etc).

5. This converged system supports shared spectrum, shared bandwidth and QoS (quality of service) guarantee which is very essential for wireless communications.

6. The user (with the above mentioned terminal) uses same personal number, but is associated with different wireless systems with different air-interfaces for related applications. For example (but not limited to), the terminal automatically switches to the wireless access mode when the user is in office, home, shopping center or airport, etc, and configures to wireless mobile mode when the user is on the freeway or beach.

7. This convergence is extremely important for the global standardization of wireless communications.

The invention of this converged broadband wireless includes two parts:

First, the invention presents a new and generic architecture of converged broadband wireless networks where the CAP (Common Access Point) acts as the open function entity between the converged wireless terminal and the backbone All-IP or PDM networks. On the side of the converged wireless terminal, the CAP can support all wireless common air interfaces; on the side of the backbone networks, the CAP can support all wireline network interfaces.

Second, the invention is directed to a CAI-BIOS (Common Air Interface-Basic Input/Output System) which is the most important technical breakthrough in the design of this converged broadband wireless terminal and the CAP. With this CAI-BIOS, the different air interfaces (or different wireless standards) can be mapped to an open baseband and control processing engine as well as the RF units, etc. In the case of the CAP design, these different air interfaces modules can be uploaded from the backbone networks, remote networks or stay in the CAP disks, etc. In the case of the wireless terminal, these air interfaces modules can be loaded from the SIM card, memory stick or others.

In addition, this CAI-BIOS is very important for the future convergence of wireless communications and computers as the two BIOSs (CAI-BIOS and the PC-BIOS) may integrate into one when the beautiful wireless life is approaching.

The inventive architecture of the converged broadband wireless network is also very important because the CAP is a public open access entity to be able to support any converged wireless terminal as well as any other terminals (with this BIOS). In other words, the wireless terminal (with CAI-BIOS) can connect to any CAP within the service area. Further more, any terminal (wireless or wireline, but with this BIOS definition) can connect to any CAP in these All-IP networks.

### BRIEF DESCRIPTION OF THE DRAWING

FIG.1 is a basic block of conventional wireless communications;

FIG.2 is the invented architecture of the converged broadband wireless communications;

FIG.3 is the invented architecture of the Common Access Point with CAI-BIOS;

FIG.4 is the invented architecture of the converged Wireless Terminal with CAI-BIOS, as well as a functional sample of the designed terminal.

### DESCRIPTION OF THE PREFERRED EMBODIMENT

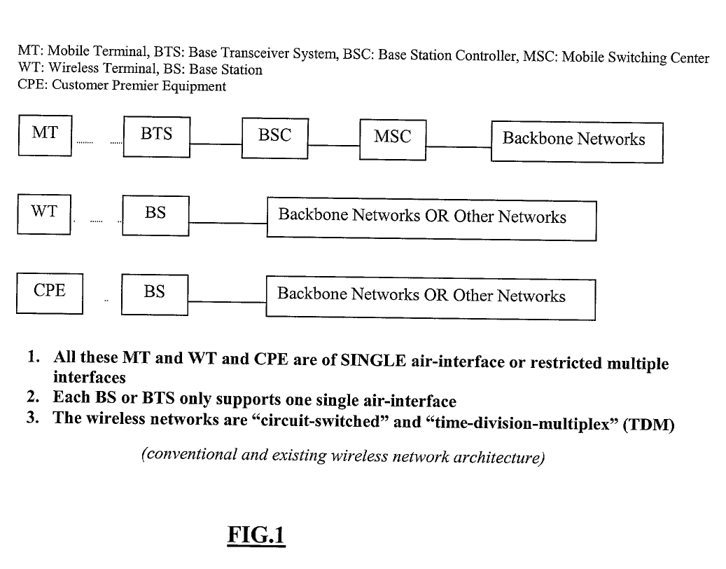

FIG. 1 is a basic block of the conventional wireless communications where each terminal and base station only supports one single air-interface, and the wireless network is “circuit-switched” and “time division multiplexed”. Hence, for different applications and air interfaces, different equipments must be used. This architecture is very expensive, poor spectrum utilization and not cost-effective, etc.

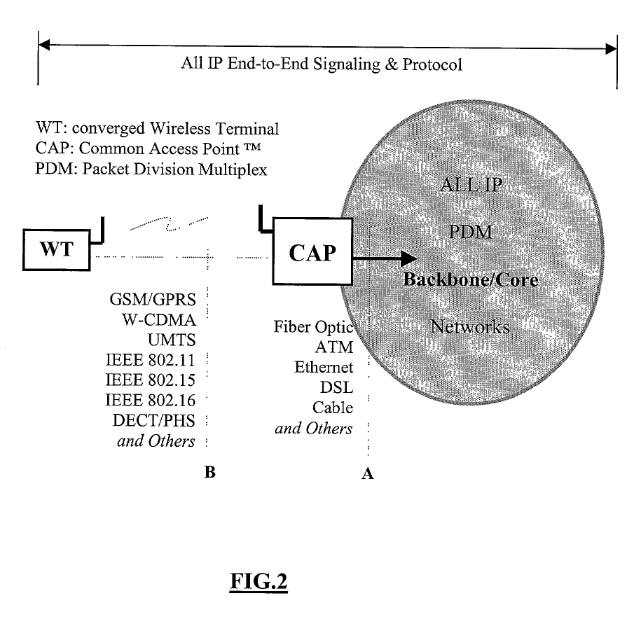

FIG. 2 shows the invention of the new architecture of the converged broadband wireless communications. All the basestation equipments (BTS, BSC, MSC, etc.) are integrated into one open function entity called “Common Access Point” (CAP). On the right side of CAP (see “A” in FIG.2), it supports any network interfaces to the All-IP or PDM (packet division multiplex) backbone core networks; on the left side of CAP (see “B” in FIG.2), it connects all common air interfaces (or wireless standards). The All-IP protocol has been extended to the converged Wireless Terminal (WT), and the wireless signaling is now End-to-End which makes the WT a very smart terminal (e.g. Security, Information Recognition and Bandwidth-on-Demand, etc).

The CAP is really a breakthrough because it provides a public and open access function to the backbone All-IP PDM networks which greatly simplifies the wireless networks. The convergence of different common air interfaces greatly improves the design of traditional wireless transceiver systems. Each user (with this same and one converged wireless terminal) has only one personal number, but is capable to communicate in different air interfaces—either automatically or manually.

Because of the All-IP PDM model, the “physical” switching is not necessary or just combined with the backbone networks. The previous base-station controlling has been partially distributed to the backbone networks and to the smart wireless terminals (end-to-end direct signaling) as well as the CAP.

This architecture is also essential for the future total convergence of wireline communications and wireless communications when at that time, any terminal can connect to any CAP anywhere in the All-IP PDM networks.

This inventive architecture improves the optimal utilization of wireless spectrum, bandwidth, wireless traffic control and wireless system performance.

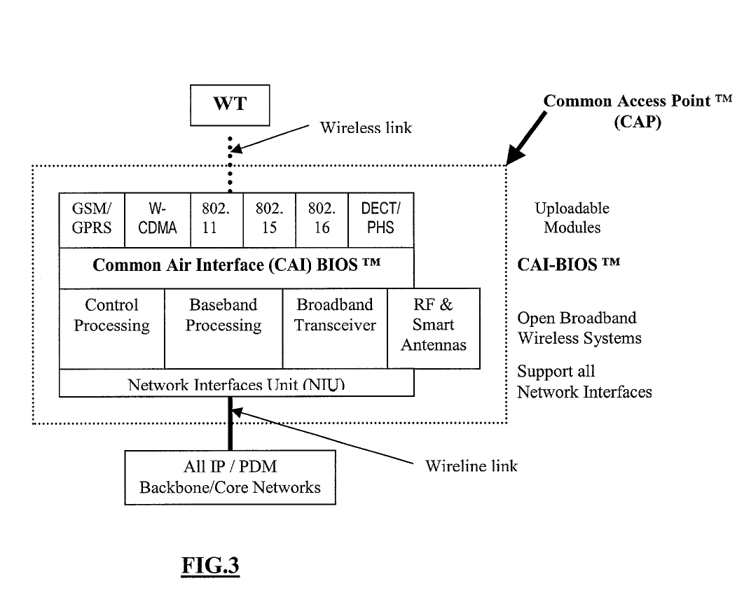

FIG.3 shows the invented architecture of the Common Access Point (CAP). The key function block of CAP is the Common Air Interface-Basic Input/Output System (CAI-BIOS) which maps the different air interfaces modules (GSM, GPRS, UMTS, 802.11, 802.15, 802.16, WLL, etc) to the open processing engines (base-band and control) as well as broadband transceivers and RF/IF modules. These common air interfaces modules can be uploadable from the backbone networks, remote networks or just stay in the local CAP disks, etc. The network interface unit (NIU) supports all network interfaces (Fiber Optical, ATM, DSL, Cable, Ethernet, etc) to the backbone All-IP PDM networks.

This generic architecture is very friend to any new air interface modules or network interface modules, and very important for future multi-dimensional convergence of wireless and wireline communications, communications and computers, etc.

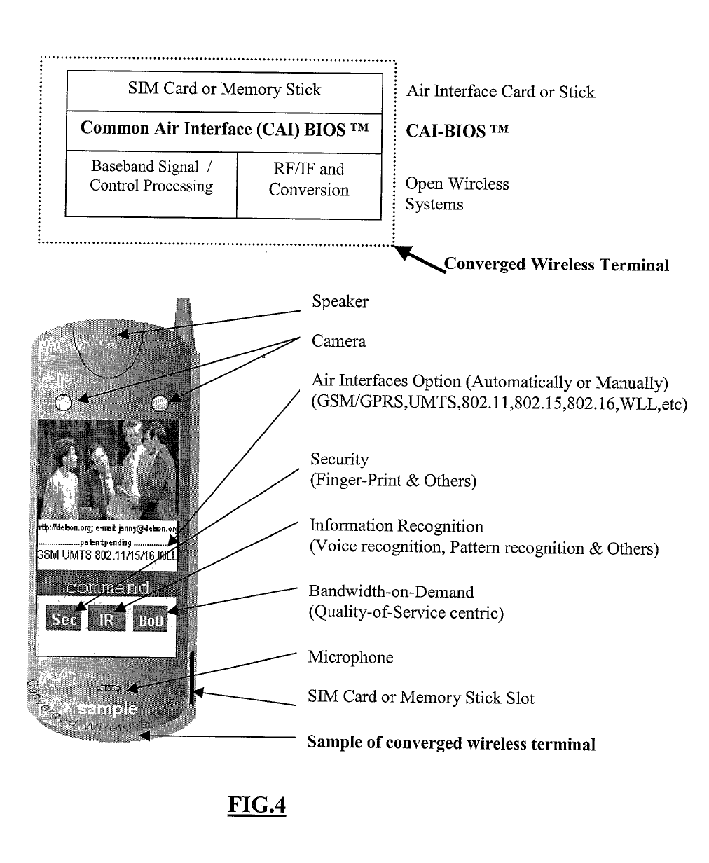

FIG.4 shows the invented architecture of the converged Wireless Terminal with the CAI-BIOS as the key function unit. Same as in CAP, the CAI-BIOS maps the common air interface modules to the open processing engines, the broadband conversion unit and the RF/IF unit, and vice verse. However, because the wireless spectrum is very expensive and the terminal capacity (processing, memory, power, etc) is very limited, we need to use the SIM card or Memory Stick, etc to load the different common air interfaces modules.

As an example, FIG.4 also shows a sample of this converged wireless terminal. The terminal can automatically connect to the CAP through one available air interface (wireless access preferable as first choice). But the user has the option to select his favorable air interface within the service area.

Three commands (Input or Output) are necessary:

Security, including Finger Print or others. This is to establish the relation between this converged wireless terminal and the user. By printing your finger into this “hole”, you are responsible to pay the services, contents, etc for the communications. Any registered users can use this converged wireless terminal.

Information Recognition, including voice recognition and pattern recognition. There is no keyboard or keypad available for this converged wireless terminal. After you use the terminal, your voice pattern gets trained or you can input your initial pattern when signing-up for the service. But the user still can have the option to purchase the additional small wireless keyboard supported by this converged wireless terminal. Other pattern recognition is also supported.

Bandwidth-on-Demand. The terminal can provide an automatic datarate for each service, but the user has the option to select other datarate and request more bandwidth by pressing this “button”.

I CLAIM

1.An architecture for Converged Broadband Wireless Communications CHARACTERIZED BY:
(1) a converged wireless terminal comprising:
(a) a block radio-frequency and intermediate-frequency and digital broadband transceiver for converting between the base-band signal and the radio frequency, and
(b) a block base-band signal and control signal processing engine for processing various wireless algorithms and protocols, and
(c) a Common Air Interface Basic Input/Output System (CAI-BIOS) for the mapping and controlling of different wireless air-interfaces (wireless standards) to the said broadband transceiver and the said processing engine, and
(d) a SIM (Smart Integrated Memory) card or Memory Stick for the loading of different air interfaces and their software modules to the said CAI-BIOS
(2) a Common Access Point (CAP) comprising:
(a) a block radio-frequency and smart antennas and broadband transceiver for converting between the base-band signal and the radio frequency, and
(b) a block base-band signal and control signal processing engine for processing various wireless algorithms and protocols, and
(c) a Common Air Interface Basic Input/Output System (CAI-BIOS) for the mapping and controlling of different wireless air-interfaces (wireless standards) to the said broadband transceiver and the said processing engine, and
(d) a group of software modules providing various air interfaces (wireless standards) to the said CAI-BIOS, and
(e) a block network interface unit for connecting to the backbone wireline networks.
(3) An All-IP (Internet Protocol) Packet Division Multiplex (PDM) backbone or core network comprising:
(a) Any conventional or future PDM network, or
(b) Any public or private PDM network.

2. The architecture for Converged Broadband Wireless Communications of claim 1 wherein:
said Common Access Point supports any network interfaces (for example, Fiber Optic, ATM, Ethernet, Digital Subscriber Line, Cable, etc) to the said PDM backbone network through wireline link;
said Common Access Point supports any air interfaces (for example, GSM/GPRS, W-CDMA, UMTS, IEEE 802.11, 802.15, 802.16 and Wireless Local Loop, etc) to the said converged wireless terminal through wireless air link;
said converged wireless terminal supports any said air interfaces to the said common access point through wireless air link.

3. The architecture for Converged Broadband Wireless Communications of claim 1 wherein:
said converged wireless terminal and said common access point are all open function units and can be reconfigurable, programmable and software definable;
said converged wireless terminal and said common access point can automatically or manually run in any of the said air interfaces subject to the service availability;
said common access point can automatically or manually run in any of the said network interfaces subject to the service availability.

4. The architecture for Converged Broadband Wireless Communications of claim 1 wherein:
said converged wireless terminal and said common access point are communicating through All-IP end-to-end direct signaling and protocol;
said converged wireless terminal and said common access point support integrated services of voice, data and video over All-IP protocol and signaling.

5. The architecture for Converged Broadband Wireless Communications of claim 1 wherein:
said CAI-BIOS performs the mapping and controlling between said different air interfaces and the said open base-band/control processing engine, the said broadband transceiver as well as the said radio frequency unit;
said CAI-BIOS is the key unit of the said converged wireless terminal and the said common access point;
said CAI-BIOS provides information on said air interfaces including necessary transmission parameters, modulation parameters, channel parameters, access control parameters, dynamic bandwidth allocation parameters and other specific air interface parameters.

6. The architecture for Converged Broadband Wireless Communications of claim 2 wherein:
said air interfaces modules in said common access point can be stored in said common access point disks or uploaded from the said PDM backbone networks or uploaded from other remote networks;
said air interfaces modules in said converged wireless terminal can be loaded in said SIM card or memory stick.

7. The architecture for Converged Broadband Wireless Communications of claim 1 wherein:
said IP means any version of Internet Protocol or its future development of packet-oriented protocol.

8. A sample product of said converged wireless terminal CHARACTERIZED BY:
(a) Air Interfaces Options (automatically or manually), and
(b) Security (finger print, etc), and
(c) Information recognition (voice recognition, pattern recognition, etc)
(d) Bandwidth on Demand (Quality of Service Centric)
(e) SIM card or memory stick
